(19) United States
(12) Patent Application Publication
(10) Pub. No.: US 2026/0325894 A1
(43) Pub. Date: Oct. 22, 2026

(54) PARKING FIRE PREVENTION DEVICE AND FIRE BLANKET AUTOMATIC LIFTING DEVICE THEREOF

(71) Applicant: KINPO ELECTRONICS, INC., NEW TAIPEI CITY (TW)

(72) Inventor: Chun-Chieh CHANG, NEW TAIPEI CITY (TW)

(73) Assignee: KINPO ELECTRONICS, INC., NEW TAIPEI CITY (TW)

(21) Appl. No.: 19/251,009

(22) Filed: Jun. 26, 2025

(30) Foreign Application Priority Data
Apr. 22, 2025 (TW) 114115189

(51) Int. Cl. A62C 3/07; A62C 8/06; A62C 37/38

(52) U.S. Cl. CPC A62C 3/07; A62C 8/06; A62C 37/38

(57) ABSTRACT

A parking fire prevention device and a fire blanket automatic lifting device thereof are disclosed. The parking fire prevention device includes a parking platform configured to accommodate a vehicle, the fire blanket automatic lifting device arranged on the parking platform, and a flame retardant gas supplier. The fire blanket automatic lifting device includes a fire blanket and an automatic lifting mechanism connected to the fire blanket to store or deploy it. When deployed, the fire blanket is driven by the lifting mechanism to cover the parking platform at a distance from the vehicle, such that a closed chamber enclosing the vehicle from the outside is defined between the fire blanket and the parking platform. A clearance space is formed between the fire blanket and the vehicle. The flame retardant gas supplier is configured to correspond to the closed chamber and fill the clearance space with a flame retardant gas.

### CROSS-REFERENCE TO RELATED APPLICATION

This application claims benefit of priority to Taiwanese Patent Application No. 114115189 filed Apr. 22, 2025, the entire contents of which are incorporated herein by reference.

### BACKGROUND OF THE INVENTION

### Technical Field

The present disclosure relates to a fire extinguishing device for vehicle, particularly to a parking fire prevention device and a fire blanket automatic lifting device thereof.

### Description of Related Art

Electric vehicles are powered by batteries that operate through charging and discharging cycles. Lithium batteries, in particular, offer advantages such as high open-circuit voltage, high energy density, long driving range, low self-discharge rate, and extended service life. As a result, lithium batteries have become a commonly adopted power source among electric vehicle manufacturers.

Lithium batteries tend to heat up during charging via charging piles, which may lead to a small probability of spontaneous combustion. When spontaneous combustion occurs, the fire may easily spread to surrounding electric vehicles to cause the fire to expand rapidly. Therefore, a fire blanket that is used to cover the outside of electric vehicles to extinguish fires has appeared on the market.

However, the fire blanket is mainly made of woven glass fiber, such that it may melt and rupture due to excessive contact with fire source to cause fireproof failure. In addition, the existing fire blanket is used to directly cover and attach to the outside of the electric vehicle to extinguish the fire by blocking the air. However, people tend to mistake the fire having been extinguished by the covered fire blanket. It is very easy for the fire to reignite due to the injection of air when the fire blanket is lifted, which makes it difficult to judge whether the fire has been actually extinguished.

In view of the above, the inventor seeks to overcome the aforementioned drawbacks associated with the current technology and aims to provide an effective solution through extensive researches along with utilization of academic principles and knowledge.

### SUMMARY OF THE INVENTION

The present disclosure provides a parking fire prevention device and a fire blanket automatic lifting device thereof, which uses a clearance space formed between the fire blanket and the vehicle to be filled with the flame retardant gas by the flame retardant gas supplier to improve the using safety of the parking fire prevention device and the fire blanket automatic lifting device.

To accomplish the aforementioned objective, the present disclosure provides a parking fire prevention device. The parking fire prevention device includes a parking platform, a fire blanket automatic lifting device, and a flame retardant gas supplier. The parking platform is configured to accommodate a vehicle. The fire blanket automatic lifting device is arranged on the parking platform and includes a fire blanket and an automatic lifting mechanism connected to the fire blanket and configured to store or deploy the fire blanket. When the fire blanket is deployed by the automatic lifting mechanism, the fire blanket is driven by the automatic lifting mechanism to cover the parking platform at a distance from the vehicle, until the fire blanket and the parking platform define a closed chamber enclosing the vehicle from the outside. A clearance space is formed between the fire blanket and the vehicle. The flame retardant gas supplier is disposed in correspondence with the closed chamber and configured to fill a flame retardant gas into the clearance space.

To accomplish the aforementioned objective, the present disclosure provides a fire blanket automatic lifting device. The fire blanket automatic lifting device is arranged on a parking platform to park a vehicle. The fire blanket automatic lifting device includes a fire blanket, an automatic lifting mechanism, and a flame retardant gas supplier. The automatic lifting mechanism is connected to the fire blanket and configured to store or deploy the fire blanket. When the fire blanket is deployed by the automatic lifting mechanism, the fire blanket is driven by the automatic lifting mechanism to cover the parking platform at a distance from the vehicle, until the fire blanket and the parking platform define a closed chamber enclosing the vehicle from the outside. A clearance space is formed between the fire blanket and the vehicle. The flame retardant gas supplier is disposed in correspondence with the closed chamber and configured to fill a flame retardant gas into the clearance space.

In the parking fire prevention device and the fire blanket automatic lifting device thereof of the present disclosure, the flame retardant gas supplier fills the flame retardant gas into the clearance space to extinguish the fire, so as to prevent the fire blanket from melting and rupturing due to excessive contact with fire source. In addition, since the clearance space is filled with the flame retardant gas, an oxygen concentration may be prevented from rapidly increasing to cause the fire to reignite when the fire blanket is lifted, so as further to strengthen the using safety of the parking fire prevention device and the fire blanket automatic lifting device.

### BRIEF DESCRIPTION OF THE DRAWNINGS

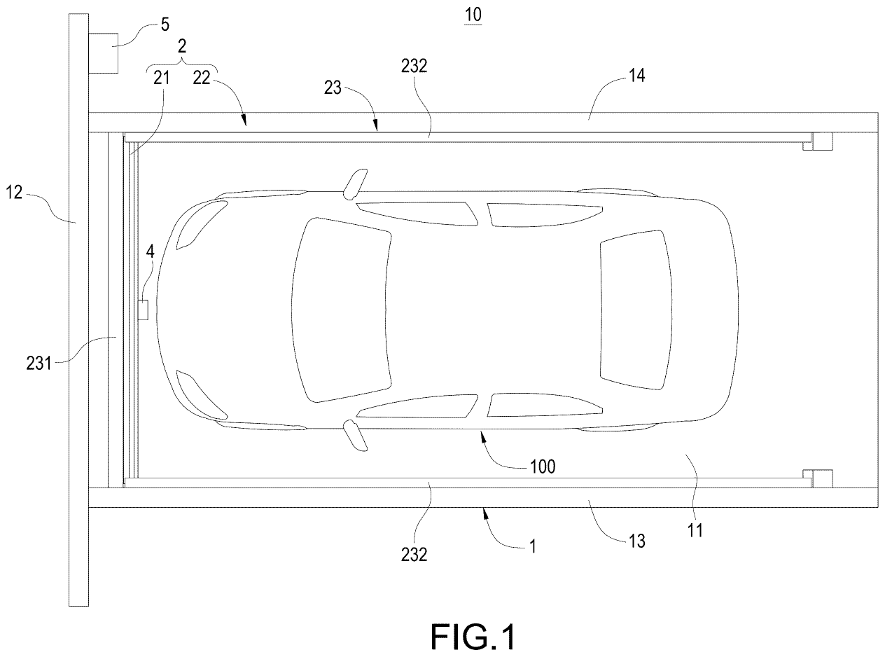

FIG. 1 is a top view of the parking fire prevention device of the present disclosure;

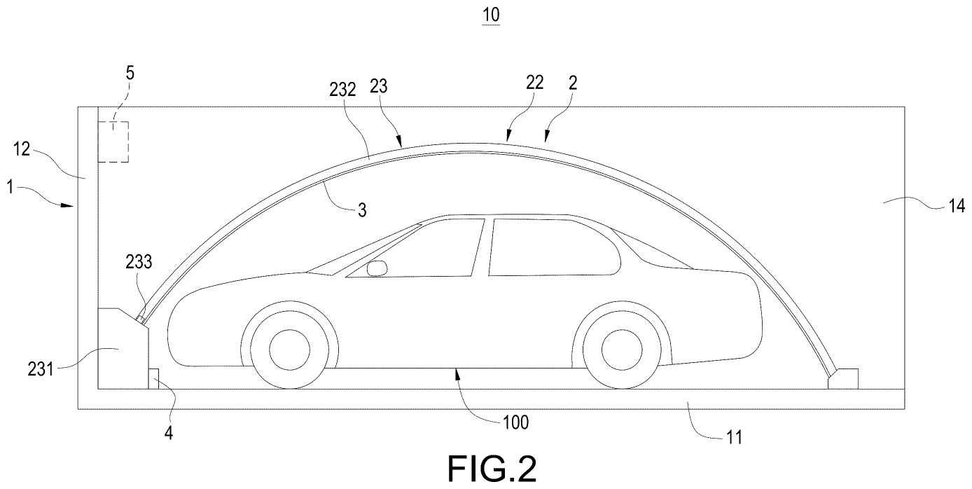

FIG. 2 is a side view of the parking fire prevention device of the present disclosure in using status;

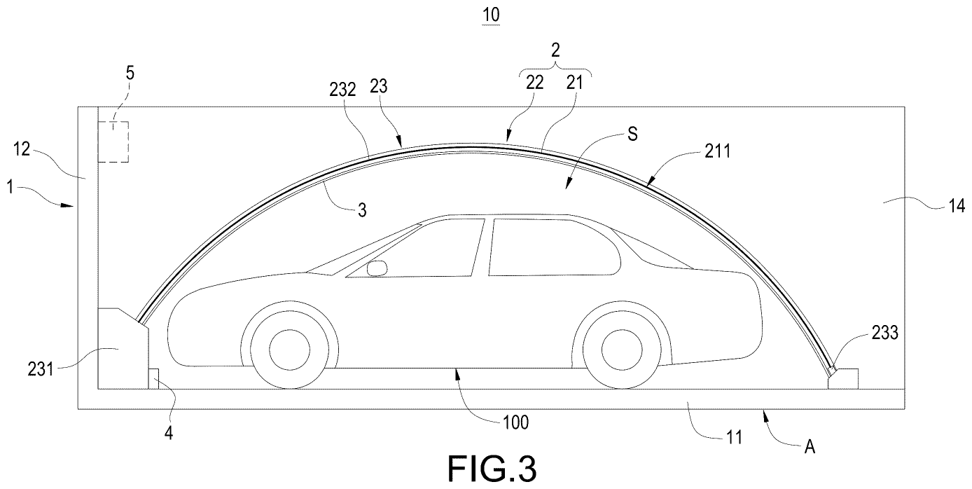

FIG. 3 is another side view of the parking fire prevention device of the present disclosure in using status;

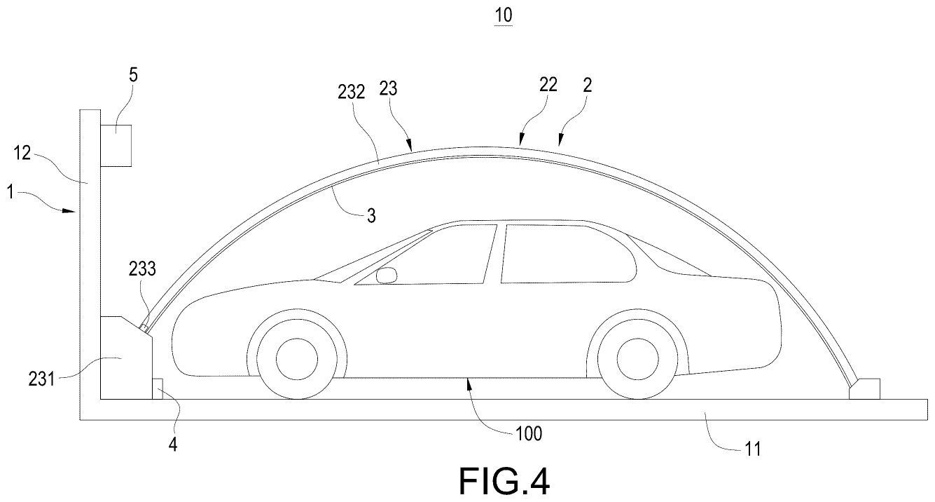

FIG. 4 is a side view of the parking fire prevention device of another embodiment of the present disclosure in using status;

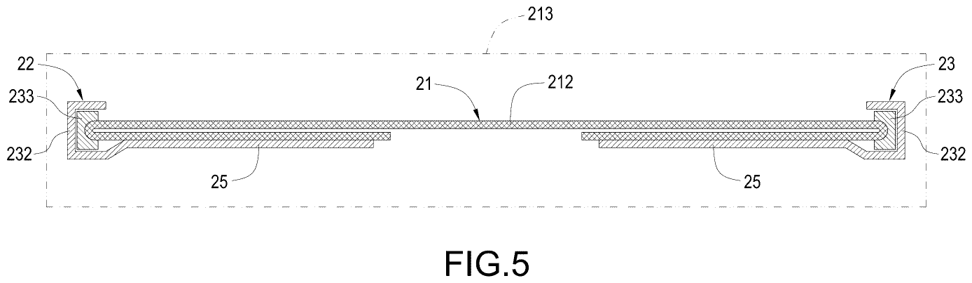

FIG. 5 is a cross-sectional side view showing the automatic lifting mechanism storing the fire blanket according to the present disclosure;

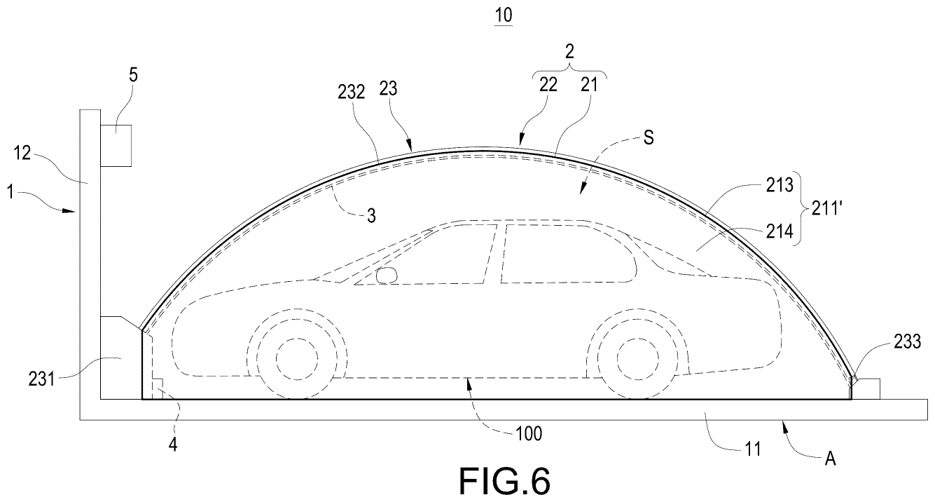

FIG. 6 is another side view of the parking fire prevention device of another embodiment of the present disclosure in using status;

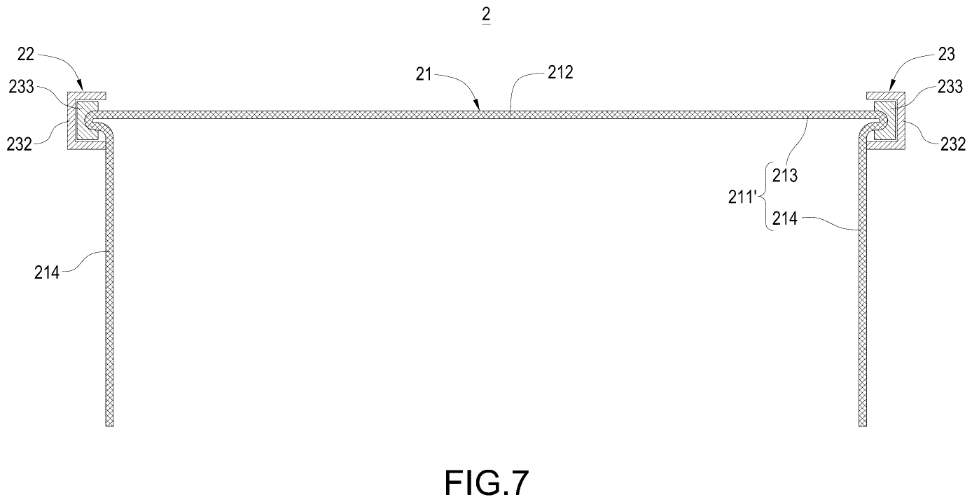

FIG. 7 is a cross-sectional side view showing the automatic lifting mechanism deploying the fire blanket according to the present disclosure;

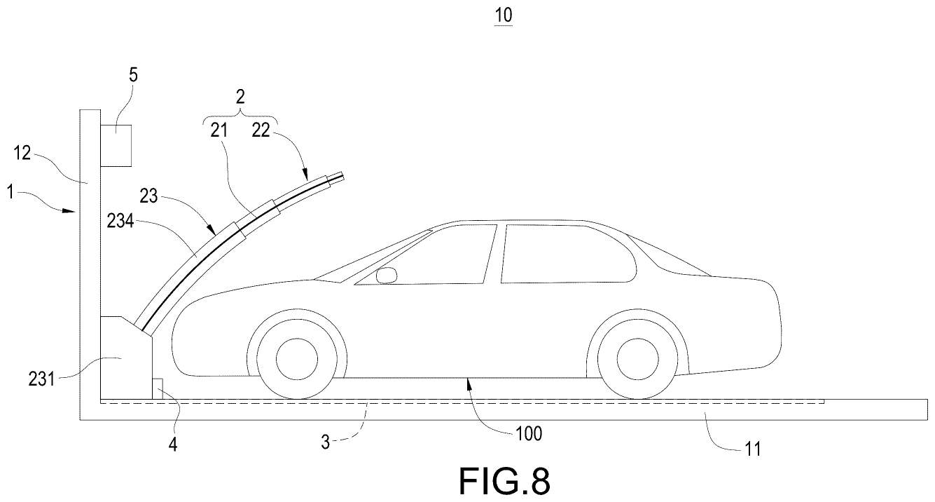

FIG. 8 is a side view of the parking fire prevention device of still another embodiment of the present disclosure in using status;

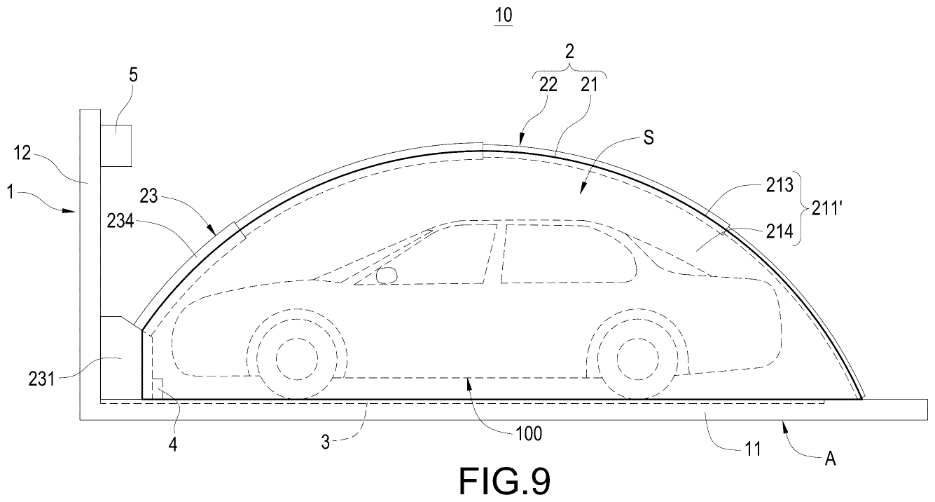

FIG. 9 is another side view of the parking fire prevention device of still another embodiment of the present disclosure in using status;

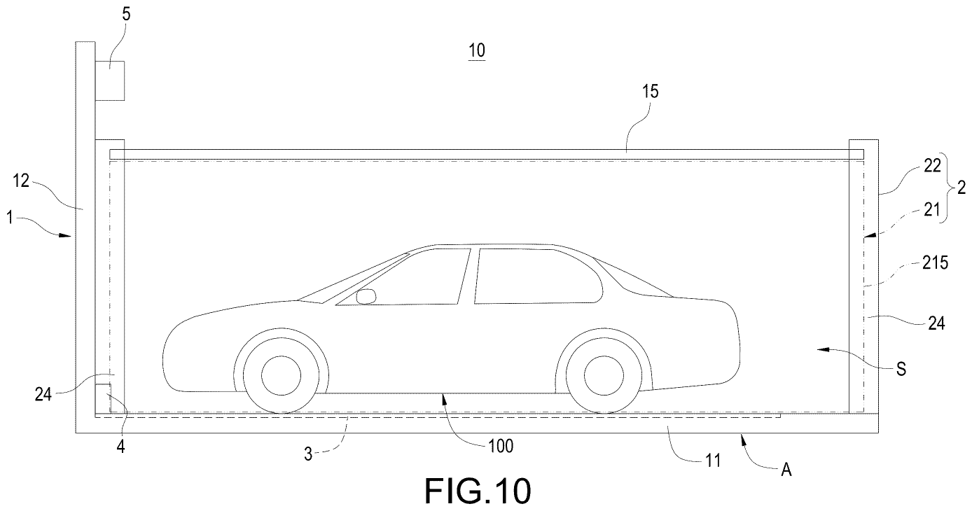

FIG. 10 is a side view of the parking fire prevention device of yet another embodiment of the present disclosure in using status; and

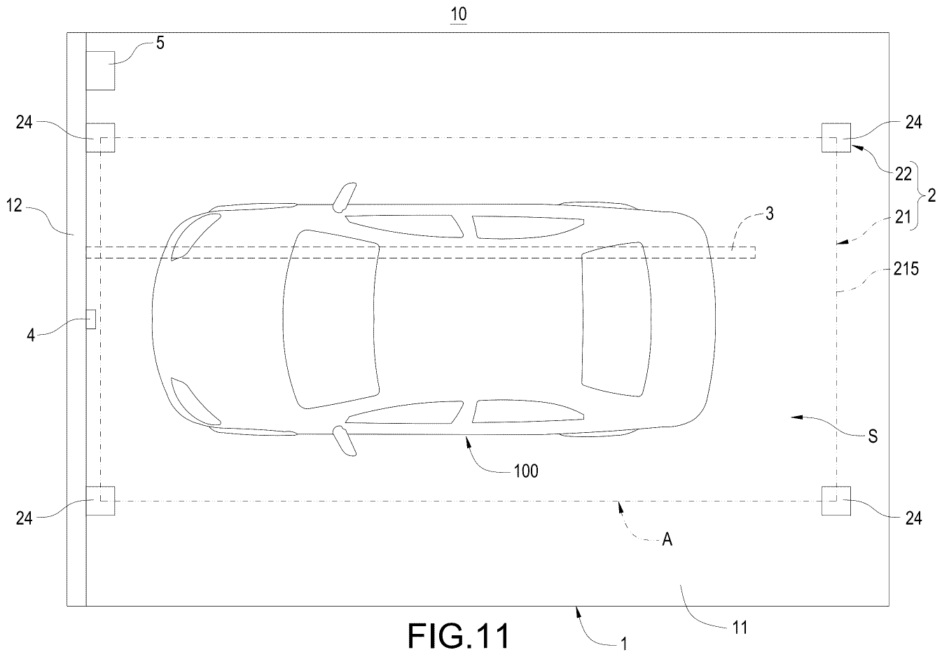

FIG. 11 is a top view of the parking fire prevention device of yet another embodiment of the present disclosure in using status.

### DETAILED DESCRIPTION

The technical contents of the present disclosure will become apparent with the detailed description of embodiments and the accompanied drawings as follows. However, it shall be noted that the accompanied drawings are for illustrative purposes only such that they shall not be used to restrict the scope of the present disclosure.

Please refer to FIG. 1, FIG. 2 and FIG. 3, the present disclosure provides a parking fire prevention device 10 and a fire blanket automatic lifting device 2 thereof, which are used for a vehicle 100. The parking fire prevention device 10 mainly includes a parking platform 1, the fire blanket automatic lifting device 2, and a flame retardant gas supplier 3. The fire blanket automatic lifting device 2 mainly includes a fire blanket 21, an automatic lifting mechanism 22, and a flame retardant gas supplier 3.

As shown in FIG. 1, FIG. 2 and FIG. 3, the parking platform 1 has a charging pile (not shown in figures), and the parking platform 1 is used for the vehicle 100 to park and be charged by the charging pile. The parking platform 1 of the embodiment has a bottom floor 11, a front wall 12, a left wall 13, and a right wall 14, and the vehicle 100 is parked on the bottom floor 11.

As shown in FIG. 1, FIG. 2 and FIG. 3, the fire blanket automatic lifting device 2 is arranged on the parking platform 1. The fire blanket automatic lifting device 2 includes a fire blanket 21 and an automatic lifting mechanism 22 connected to the fire blanket 21 and configured to store or deploy the fire blanket 21. When the fire blanket 21 is deployed by the automatic lifting mechanism 22, the fire blanket 21 is driven by the automatic lifting mechanism 22 to cover the parking platform 1 at a distance from the vehicle 100 (that is the fire blanket 21 does not attach to the vehicle 100), until the fire blanket 21 and the parking platform 1 define a closed chamber A enclosing the vehicle 100 from the outside. At this point, a clearance space S is formed between the fire blanket 21 and the vehicle 100.

Details are provided as follows. The automatic lifting mechanism 22 of the embodiment includes an arc lifting module 23. The arc lifting module 23 is configured to deploy the fire blanket 21 to be an arc awning 211 covering at least part of the parking platform 1, but the present disclosure is not limited to this embodiment. The closed chamber A is formed by the arc awning 211 and the parking platform 1. The flame retardant gas supplier 3 is arranged on the arc lifting module 23.

In addition, the arc lifting module 23 of the embodiment includes a fixing seat 231, a pair of arc tracks 232, and an automatic puller 233. The fixing seat 231 is arranged on a front end of the bottom floor 11. Each of the arc tracks 232 is arranged on the left wall 13 and the right wall 14, and two ends of each of the arc tracks 232 are respectively connected to the fixing seat 231 and a rear end of the bottom floor 11. The automatic puller 233 is configured to slide along each of the arc tracks 232. Two ends of the fire blanket 21 are respectively secured to the fixing seat 231 and the automatic puller 233 to be driven by the automatic puller 233. In the embodiment, the automatic puller 233 may be a driver or a slider or a pulley driven to slide in each of the arc tracks 232 by the driver, but the present disclosure is not limited to this embodiment. The fixing seat 231 of the embodiment is arranged on a front side of the bottom floor 11 such that the front wall 12 is a non-essential member and may be omitted according to different needs.

As shown in FIG. 2 and FIG. 3, the flame retardant gas supplier 3 of the embodiment is arranged on the pair of arc tracks 232, but the present disclosure is not limited to this embodiment. For example, the flame retardant gas supplier 3 may also be arranged on the bottom floor 11, the left wall 13, or the right wall 14 as long as the flame retardant gas supplier 3 can be accommodated in any position of the closed chamber A such that the flame retardant gas supplier 3 is accommodated in and corresponding to the closed chamber A. The flame retardant gas supplier 3 is used for filling a flame retardant gas into the clearance space S. The flame retardant gas includes at least one of heptafluoropropane (HFP), carbon dioxide (CO2), and nitrogen (N2).

As shown in FIG. 1, FIG. 2, and FIG. 3, the parking fire prevention device 10 of the present disclosure further includes a temperature monitor 4. The temperature monitor 4 of the embodiment is arranged on the fixing seat 231, but the present disclosure is not limited to this embodiment. For example, the temperature monitor 4 may also be arranged on the bottom floor 11, the left wall 13, of the right wall 14 as long as the temperature monitor 4 can be accommodated in any position of the closed chamber A such that the temperature monitor 4 is accommodated in and corresponding to the closed chamber A. The temperature monitor 4 outputs a high temperature signal when it detects that a temperature is higher than a preset high temperature value. The temperature monitor 4 outputs a low temperature signal when it detects that a temperature is lower than a preset low temperature value. The automatic lifting mechanism 22 deploys the fire blanket 21 after receiving the high temperature signal, and the flame retardant gas supplier 3 fills the flame retardant gas into the clearance space S after receiving the high temperature signal. The automatic lifting mechanism 22 stores the fire blanket 21 after receiving the low temperature signal, and the flame retardant gas supplier 3 stops supplying the flame retardant gas into the clearance space S after receiving the low temperature signal.

Details are provided as follows. In the embodiment, the automatic puller 233 drives the fire blanket 21 to deploy the fire blanket 21 to be the arc awning 211 located above the vehicle 100 after receiving the high temperature signal. The closed chamber A is formed by the arc awning 211, the left wall 13, the right wall 14, and the bottom floor 11. The automatic puller 233 drives the fire blanket 21 to store the fire blanket 21 into th fixing seat 231 after receiving the low temperature signal.

In addition, the fixing seat may also be arranged on the front wall 12, but the present disclosure is not limited to this embodiment. When the fixing seat is arranged on the front wall 12, the closed chamber A is formed by the arc awning 211, the left wall 13, the right wall 14, the front wall 12, and the bottom floor 11.

As shown in FIG. 1, FIG. 2, and FIG. 3, the parking fire prevention device 10 of the present disclosure further includes an accident alarm 5. The accident alarm 5 is arranged on the parking platform 1 and configured to correspond to an outer side of the closed chamber A. That is, the accident alarm 5 would not be arranged in the closed chamber A to prevent the accident alarm 5 from affecting by the fire and ensure that the accident alarm 5 may operate normally. Therefore, the accident alarm 5 may rapidly output an alert notification after receiving the high temperature signal, and the accident alarm 5 outputs a safety notification after receiving the low temperature signal. The accident alarm 5 may be any warning device such as warning lights or whistles to issue the alarm notifications such as red lights, sirens or notifying to fire departments, and the safety notifications such as green lights or stop sirens.

As shown in FIG. 2 and FIG. 3, the parking fire prevention device 10 and the fire blanket automatic lifting device 2 of the present disclosure are used when the vehicle 100 spontaneously ignites during the charging process of the charging pile. When spontaneous combustion occurs, the temperature monitor 4 outputs the high temperature signal when it detects that the temperature is higher than the preset high temperature value, such that the automatic lifting mechanism 22 drives the fire blanket 21 and the parking platform 1 to together form the closed chamber A surrounding the vehicle 100, and the clearance space S is formed between the fire blanket 21 and the vehicle 100. At the same time, the flame retardant gas supplier 3 fills the flame retardant gas into the clearance space S to extinguish the fire, and the accident alarm 5 outputs the alert notification to notify that a fire has occurred, so as to strengthen the using safety of the parking fire prevention device 10 and the fire blanket automatic lifting device 2.

On the other hand, when the fire is extinguished, the temperature monitor 4 outputs the low temperature signal when it detects that the temperature is lower than the preset low temperature value, such that the automatic lifting mechanism 22 stores the fire blanket 21 into the fixing seat 231. At the same time, the accident alarm 5 outputs a safety notification to notify that the fire has extinguish, or the automatic lifting mechanism 22 may lift the fire blanket 21 by electric or manual when rescue is needed, so as to increase the using convenience of the parking fire prevention device 10 and the fire blanket automatic lifting device 2.

In addition, compared with the existing fire extinguishing method using the fire blanket 21 to directly cover and attach to outside of the vehicle 100, the present disclosure has the clearance space S between the fire blanket 21 and the vehicle 100 to be filled with the flame retardant gas by the flame retardant gas supplier 3, so as to prevent the fire blanket 21 from melting and rupturing due to excessive contact with fire source. In addition, since the clearance space S is filled with the flame retardant gas, an oxygen concentration may be prevented from rapidly increasing to cause the fire to reignite when the fire blanket 21 is lifted, so as further to strengthen the using safety of the parking fire prevention device 10 and the fire blanket automatic lifting device 2.

Furthermore, the automatic lifting mechanism 22 of the embodiment includes the arc lifting module 23 that may deploy the fire blanket 21 to be the arc awning 211 covering the parking platform 1, such that the single fire blanket 21 is therefore surrounding the front side, rear side, and top side of the parking platform 1. Therefore, the parking fire prevention device 10 and the fire blanket automatic lifting device 2 may simplify the structure, save the cost, and improve the shortcoming that the existing fire blanket 21 may drop down because of failure.

Please refer to FIG. 4, FIG. 5, FIG. 6, and FIG. 7, which is another embodiment of the parking fire prevention device 10 and the fire blanket automatic lifting device 2 of the present disclosure. The main difference between the embodiment of FIG. 4, FIG. 5, FIG. 6, and FIG. 7 and the embodiment of FIG. 1, FIG. 2, and FIG. 3 is the structure of the parking platform 1 and the fire blanket 21.

Details are provided as follows. The parking platform 1 of the embodiment merely has the bottom floor 11, and the front wall 12 is a non-essential member. The arc lifting module 23 includes the fixing seat 231, the pair of arc tracks 232, and the automatic puller 233. The fixing seat 231 is arranged on the front end of the bottom floor 11. Each of the arc tracks 232 is arranged on the left end and the right end of the bottom floor 11. Two ends of each of the arc tracks 232 are respectively connected to the fixing seat 231 and the rear end of the bottom floor 11, such that two hollow openings (not shown in figures) are formed between each of the arc tracks 232 and the bottom floor 11. The automatic puller 233 is configured to slide along each of the arc tracks 232.

In addition, as shown in FIG. 6 and FIG. 7, in the embodiment, two ends of the fire blanket 21 are respectively secured to the fixing seat 231 and the automatic puller 233, and the fire blanket 21 is inverted U-shaped. The automatic puller 233 drives the inverted U-shaped fire blanket 212 to deploy the inverted U-shaped fire blanket 212 to be the arc awning 211′ after receiving the high temperature signal. The arc awning 211′ has an arc top cover 213 located above the vehicle 100 and two side panels 214 respectively located on left side and right side of the vehicle 100 and perpendicular to the bottom floor 11. Each of the side panels 214 covers each of the hollow openings formed between each of the arc tracks 232 and the bottom floor 11, such that the closed chamber A is formed by the arc top cover 213, each of the side panels 214, and the bottom floor 11. The automatic puller 233 drives the fire blanket 21 to store the fire blanket 21 into the fixing seat 231 after receiving the low temperature signal. Therefore, this embodiment may achieve the same effects of the embodiment of FIG. 1, FIG. 2, and FIG. 3.

Furthermore, as shown in FIG. 4 and FIG. 5, a bottom end of each of the arc tracks 232 arranged on the fixing seat 231 extends a folding sheet 25 inward. When the automatic puller 233 drives the fire blanket 21 to store the fire blanket 21 into the fixing seat 231 after receiving the low temperature signal, two ends of the inverted U-shaped fire blanket 212 may be guided by the folding sheet 25 to neatly fold and store the inverted U-shaped fire blanket 212 into the fixing seat 231.

Please refer to FIG. 8 and FIG. 9, which is still another embodiment o the parking fire prevention device 10 and the fire blanket automatic lifting device 2 of the present disclosure. The main difference between the embodiment of FIG. 8 and FIG. 9 and the embodiment of FIG. 4, FIG. 5, FIG. 6, and FIG. 7 is the structure of the arc lifting module 23.

Details are provided as follows. The parking platform 1 of the embodiment merely has the bottom floor 11, and the front wall 12 is a non-essential member. The arc lifting module 23 includes the fixing seat 231 and a pair of arc telescopic rods 234. The fixing seat 231 is arranged on the front end of the bottom floor 11. Each of the arc telescopic rods 234 is arranged on the left end and the right end of the bottom floor 11. Two ends of each of the arc telescopic rods 234 are respectively connected to the fixing seat 231 and configured to stretch toward the rear end of the bottom floor 11, such that two hollow openings (not shown in figures) are respectively formed between each of the arc telescopic rods 234 and the bottom floor 11.

In addition, please refer to FIG. 7 again. In the embodiment, two ends of the fire blanket 21 are respectively secured to the fixing seat 231 and the pair of arc telescopic rods 234, and the fire blanket 21 is inverted U-shaped. Each of the arc telescopic rods 234 extends to deploy the inverted U-shaped fire blanket 212 toward the rear end of the bottom floor 11 to be the arc awning 211′ after receiving the high temperature signal. The arc awning 211′ has the arc top cover 213 located above the vehicle 100 and two side panels 214 respectively located on left side and right side of the vehicle 100 and perpendicular to the bottom floor 11. Each of the side panels 214 covers each of the hollow openings formed between each of the arc telescopic rods 234 and the bottom floor 11, such that the closed chamber A is formed by the arc top cover 213, each of the side panels 214, and the bottom floor 11. Each of the arc telescopic rods 234 stretches to fold the fire blanket 21 toward the front end of the bottom floor 11 after receiving the low temperature signal. Therefore, this embodiment may achieve the same effects of the embodiment of FIG. 1, FIG. 2, and FIG. 3.

On the other hand, the flame retardant gas supplier 3 of the embodiment is arranged on the bottom floor 11, the temperature monitor 4 is arranged on the fixing seat 231, but the present disclosure is not limited to this embodiment. For example, the flame retardant gas supplier 3 and the temperature monitor 4 may also be arranged on the bottom floor 11, the fixing seat 231, or each of the arc telescopic rods 234 as long as the flame retardant gas supplier 3 and the temperature monitor 4 can be accommodated in any position of the closed chamber A, such that the flame retardant gas supplier 3 and the temperature monitor 4 are accommodated in and corresponding to the closed chamber A.

Please refer to FIG. 10 and FIG. 11, which is yet another embodiment of the parking fire prevention device 10 and the fire blanket automatic lifting device 2 of the present disclosure. The main difference between the embodiment of FIG. 10 and FIG. 11 and the embodiment of FIG. 1, FIG. 2, and FIG. 3 is the structure of the automatic lifting mechanism 22 and the fire blanket 21.

Details are provided as follows. The parking platform 1 merely has the bottom floor 11 and a top ceiling 15, and the front wall 12 is a non-essential member. The automatic lifting mechanism 22 includes a plurality of longitudinal telescopic columns 24. Each of the longitudinal telescopic columns 24 is arranged on four corners of the parking platform 1. Two ends of each of the longitudinal telescopic columns 24 are respectively arranged on one of the bottom floor 11 and the top ceiling 15 and stretched toward the other one. That is, each of the longitudinal telescopic columns 24 may be arranged on the bottom floor 11 and stretch toward the top ceiling 15, or the each of the longitudinal telescopic columns 24 may be arranged on the top ceiling 15 and stretch toward the bottom floor 11.

On the other hand, the fire blanket 21 is an annulus awning 215 surrounded and secured to each of the longitudinal telescopic columns 24. Each of the longitudinal telescopic columns 24 extends to deploy the annulus awning 215 to attach to the bottom floor 11 and the top ceiling 15 after receiving the high temperature signal, such that the closed chamber A is formed by the annulus awning 215, the bottom floor 11, and the top ceiling 15. Each of the longitudinal telescopic columns 24 stretches to fold the annulus awning 215 after receiving the low temperature signal. Therefore, this embodiment may achieve the same effects of the embodiment of FIG. 1, FIG. 2, and FIG. 3.

In addition, in the embodiment, the flame retardant gas supplier 3 and the temperature monitor 4 are arranged on the bottom floor 11, but the present disclosure is not limited to this embodiment. For example, the flame retardant gas supplier 3 and the temperature monitor 4 may also be arranged on the top ceiling 15 or each of the longitudinal telescopic columns 24 as long as the flame retardant gas supplier 3 and the temperature monitor 4 can be accommodated in any position of the closed chamber A, such that the flame retardant gas supplier 3 and the temperature monitor 4 are accommodated in and corresponding to the closed chamber A.

It shall be understood that the present disclosure may have other types of embodiments, and a person with ordinary skills in the art of the technical field of the present disclosure may make various changes and modifications corresponding to the present disclosure without deviating the principle and substance of the present disclosure; however, such corresponding changes and modification shall be considered to be within the claimed scope of the present disclosure.

What is claimed is:

1. A parking fire prevention device for a vehicle, comprising:
a parking platform, configured to accommodate the vehicle;
a fire blanket automatic lifting device, arranged on the parking platform, the fire blanket automatic lifting device comprising a fire blanket and an automatic lifting mechanism connected to the fire blanket and configured to store or deploy the fire blanket, wherein when the fire blanket is deployed by the automatic lifting mechanism, the fire blanket is driven by the automatic lifting mechanism to cover the parking platform at a distance from the vehicle, until the fire blanket and the parking platform define a closed chamber enclosing the vehicle from the outside, a clearance space formed between the fire blanket and the vehicle; and
a flame retardant gas supplier, disposed in correspondence with the closed chamber, and configured to fill the clearance space with a flame retardant gas.

2. The parking fire prevention device according to claim 1, further comprising a temperature monitor, wherein the temperature monitor is configured to correspond the closed chamber, the temperature monitor outputs a high temperature signal when the temperature monitor detects that a temperature is higher than a preset high temperature value, the temperature monitor outputs a low temperature signal when the temperature monitor detects that a temperature is lower than a preset low temperature value, the automatic lifting mechanism deploys the fire blanket after receiving the high temperature signal, the flame retardant gas supplier fills the flame retardant gas into the clearance space after receiving the high temperature signal, the automatic lifting mechanism stores the fire blanket after receiving the low temperature signal, the flame retardant gas supplier stops supplying the flame retardant gas into the clearance space after receiving the low temperature signal.

3. The parking fire prevention device according to claim 2, wherein the automatic lifting mechanism comprises an arc lifting module, the arc lifting module is configured to deploy the fire blanket to be an arc awning covering on the parking platform, the closed chamber is formed by the arc awning and the parking platform, the flame retardant gas supplier is arranged on the arc lifting module.

4. The parking fire prevention device according to claim 3, wherein the parking platform comprises a bottom floor configured for parking the vehicle, a left wall, and a right wall, the arc lifting module comprises a fixing seat, a pair of arc tracks, and an automatic puller, the fixing seat is arranged on a front end of the bottom floor, each of the arc tracks is arranged on the left wall and the right wall, two ends of each of the arc tracks are respectively connected to the fixing seat and a rear end of the bottom floor, the automatic puller is configured to slide along each of the arc tracks, two ends of the fire blanket are respectively secured to the fixing seat and the automatic puller, the automatic puller drives the fire blanket to deploy the fire blanket to be the arc awning located above the vehicle after receiving the high temperature signal, the closed chamber is formed by the arc awning, the left wall, the right wall, and the bottom floor, the automatic puller drives the fire blanket to store the fire blanket into the fixing seat after receiving the low temperature signal, the flame retardant gas supplier is arranged on the pair of arc tracks, the temperature monitor is arranged on the fixing seat.

5. The parking fire prevention device according to claim 3, wherein the parking platform comprises a bottom floor for parking the vehicle, the arc lifting module comprises a fixing seat, a pair of arc tracks, and an automatic puller, the fixing seat is arranged on a front end of the bottom floor, each of the arc tracks is arranged on a left end and a right end of the bottom floor, two ends of each of the arc tracks are respectively connected to the fixing seat and a rear end of the bottom floor, the automatic puller is configured to slide along each of the arc tracks, two ends of the fire blanket are respectively secured to the fixing seat and the automatic puller, the fire blanket is inverted U-shaped, the automatic puller drives the fire blanket to deploy the fire blanket to be the arc awning after receiving the high temperature signal, the arc awning comprises an arc top cover located above the vehicle and two side panels respectively located on left side and right side of the vehicle and perpendicular to the bottom floor, the closed chamber is formed by the arc top cover, each of the side panels, and the bottom floor, the automatic puller drives the fire blanket to store the fire blanket 21 into the fixing seat after receiving the low temperature signal, the flame retardant gas supplier is arranged on the pair of arc tracks, the temperature monitor is arranged on the fixing seat.

6. The parking fire prevention device according to claim 3, wherein the parking platform comprises a bottom floor, the vehicle is parked on the bottom floor, the arc lifting module comprises a fixing seat and a pair of arc telescopic rods, the fixing seat is arranged on a front end of the bottom floor, each of the arc telescopic rods is arranged on a left end and a right end of the bottom floor, two ends of each of the arc telescopic rods are respectively connected to the fixing seat and configured to stretch toward a rear end of the bottom floor, two ends of the fire blanket are respectively secured to the fixing seat and the pair of arc telescopic rods, the fire blanket is inverted U-shaped, each of the arc telescopic rods extends to deploy the fire blanket toward the rear end of the bottom floor to be the arc awning after receiving the high temperature signal, the arc awning comprises an arc top cover located above the vehicle and two side panels respectively located on left side and right side of the vehicle and perpendicular to the bottom floor, the closed chamber is formed by the arc top cover, each of the side panels, and the bottom floor, each of the arc telescopic rods stretches to fold the fire blanket toward the front end of the bottom floor after receiving the low temperature signal, the flame retardant gas supplier is arranged on the bottom floor, the temperature monitor is arranged on the fixing seat.

7. The parking fire prevention device according to claim 2, wherein the parking platform comprises a bottom floor and a top ceiling, the vehicle is parked on the bottom floor, the automatic lifting mechanism comprises a plurality of longitudinal telescopic columns, each of the longitudinal telescopic columns is arranged on four corners of the parking platform, two ends of each of the longitudinal telescopic columns are respectively arranged on one of the bottom floor and the top ceiling and stretched toward the other one, the fire blanket is an annulus awning surrounded and secured to each of the longitudinal telescopic columns, each of the longitudinal telescopic columns extends to deploy the annulus awning to attach to the bottom floor and the top ceiling after receiving the high temperature signal, the closed chamber is formed by the annulus awning, the bottom floor, and the top ceiling, each of the longitudinal telescopic columns stretches to fold the annulus awning after receiving the low temperature signal, the flame retardant gas supplier and the temperature monitor are arranged on the bottom floor.

8. The parking fire prevention device according to claim 2, wherein further comprising an accident alarm, wherein the accident alarm is arranged on the parking platform and configured to correspond to an outer side of the closed chamber, the accident alarm outputs an alert notification after receiving the high temperature signal, the accident alarm outputs a safety notification after receiving the low temperature signal.

9. A fire blanket automatic lifting device, arranged on a parking platform, wherein a vehicle is accommodated on the parking platform, the fire blanket automatic lifting device comprising:
a fire blanket;
an automatic lifting mechanism, connected to the fire blanket and configured to store or deploy the fire blanket, wherein when the fire blanket is deployed by the automatic lifting mechanism, the fire blanket is driven by the automatic lifting mechanism to cover the parking platform at a distance from the vehicle, until the fire blanket and the parking platform define a closed chamber enclosing the vehicle from the outside, with a clearance space formed between the fire blanket and the vehicle; and
a flame retardant gas supplier, disposed in correspondence with the closed chamber, and configured to fill the clearance space with a flame retardant gas.

10. The fire blanket automatic lifting device according to claim 9, further comprising a temperature monitor, wherein the temperature monitor is configured to correspond the closed chamber, the temperature monitor outputs a high temperature signal when the temperature monitor detects that a temperature is higher than a preset high temperature value, the temperature monitor outputs a low temperature signal when the temperature monitor detects that a temperature is lower than a preset low temperature value, the automatic lifting mechanism deploys the fire blanket after receiving the high temperature signal, the flame retardant gas supplier fills the flame retardant gas into the clearance space after receiving the high temperature signal, the automatic lifting mechanism stores the fire blanket after receiving the low temperature signal, the flame retardant gas supplier stops supplying the flame retardant gas into the clearance space after receiving the low temperature signal.

11. The fire blanket automatic lifting device according to claim 10, wherein the automatic lifting mechanism comprises an arc lifting module, the arc lifting module is configured to deploy the fire blanket to be an arc awning covering on the parking platform, the closed chamber is formed by the arc awning and the parking platform, the flame retardant gas supplier is arranged on the arc lifting module.

12. The fire blanket automatic lifting device according to claim 11, wherein the arc lifting module comprises a fixing seat, a pair of arc tracks, and an automatic puller, the fixing seat is arranged on a front end of the parking platform, each of the arc tracks is arranged on a left end and a right end of the parking platform, two ends of each of the arc tracks are respectively connected to the fixing seat and a rear end of the parking platform, the automatic puller is configured to slide along each of the arc tracks, two ends of the fire blanket are respectively secured to the fixing seat and the automatic puller, the automatic puller drives the fire blanket to deploy the fire blanket be the arc awning located above the vehicle after receiving the high temperature signal, the automatic puller drives the fire blanket to store the fire blanket into the fixing seat after receiving the low temperature signal, the flame retardant gas supplier is arranged on the pair of arc tracks, the temperature monitor is arranged on the fixing seat.

13. The fire blanket automatic lifting device according to claim 11, wherein the arc lifting module comprises a fixing seat, a pair of arc tracks, and an automatic puller, the fixing seat is arranged on a front end of the parking platform, each of the arc tracks is arranged on a left end and a right end of the parking platform, two ends of each of the arc tracks are respectively connected to the fixing seat and a rear end of the parking platform, the automatic puller is configured to slide along each of the arc tracks, two ends of the fire blanket are respectively secured to the fixing seat and the automatic puller, the fire blanket is inverted U-shaped, the automatic puller drives the fire blanket to deploy the fire blanket to be the arc awning after receiving the high temperature signal, the arc awning comprises an arc top cover located above the vehicle and two side panels respectively located on left side and right side of the vehicle and perpendicular to the parking platform, the automatic puller drives the fire blanket to store the fire blanket 21 into the fixing seat after receiving the low temperature signal, the flame retardant gas supplier is arranged on the pair of arc tracks, the temperature monitor is arranged on the fixing seat.

14. The fire blanket automatic lifting device according to claim 11, wherein the arc lifting module comprises a fixing seat and a pair of arc telescopic rods, the fixing seat is arranged on a front end of the parking platform, each of the arc telescopic rods is arranged on a left end and a right end of the parking platform, two ends of each of the arc telescopic rods are respectively connected to the fixing seat and configured to stretch toward a rear end of the parking platform, two ends of the fire blanket are respectively secured to the fixing seat and the pair of arc telescopic rods, the fire blanket is inverted U-shaped, each of the arc telescopic rods extends to deploy the fire blanket to be the arc awning after receiving the high temperature signal, the arc awning comprises an arc top cover located above the vehicle and two side panels respectively located on left side and right side of the vehicle and perpendicular to the parking platform, each of the arc telescopic rods stretches to fold the fire blanket after receiving the low temperature signal, the temperature monitor is arranged on the fixing seat.

15. The fire blanket automatic lifting device according to claim 10, wherein the automatic lifting mechanism comprises a plurality of longitudinal telescopic columns, each of the longitudinal telescopic columns is arranged on four corners of the parking platform, the fire blanket is an annulus awning surrounded and secured to each of the longitudinal telescopic columns, each of the longitudinal telescopic columns extends to deploy the annulus awning after receiving the high temperature signal, each of the longitudinal telescopic columns stretches to fold the annulus awning after receiving the low temperature signal.
